(19) United States
(12) Patent Application Publication
(10) Pub. No.: US 2024/0060650 A1
(43) Pub. Date: Feb. 22, 2024

(54) Cushioning Mechanism and Corresponding Oven

(71) Applicant: Ywhren Jeng, Ningbo (CN)

(72) Inventor: Ywhren Jeng, Ningbo (CN)

(21) Appl. No.: 18/259,446

(22) PCT Filed: Sep. 6, 2021
(86) PCT No.: PCT/CN2021/116628

§ 371 Date: Jun. 27, 2023

(30) Foreign Application Priority Data
Mar. 23, 2021 (CN) 202110306853.8

(51) Int. Cl. F24C 15/02

(52) U.S. Cl. CPC F24C 15/023

(57) ABSTRACT

The present invention relates to a cushioning mechanism. The cushioning mechanism disposed between a first main body (1) and a second main body (2), the second main body (2) connecting to the first main body (1) and capable of rotating relative to the first main body (1), the cushioning mechanism comprises a cushioning element (3); a first cushioning member (4) disposed the first main body (1); a second cushioning member (5) disposed on the second main body (2); wherein, the second cushioning member (5) is capable of rotating together with the second main body (2) in a circular motion relative to the first cushioning member (4); during movement of the second cushioning member (5), the cushioning element (3) cooperates with the first cushioning member (4) or the second cushioning member (5) to resist the movement velocity of the second cushioning member (5). This device improves the cushioning effect and broadens the applicable environment.

### TECHNICAL FIELD OF THE INVENTION

The present invention relates to the field of mechanical control, and in particular to a cushioning mechanism and an oven thereof.

### BACKGROUND OF THE INVENTION

For heavy articles with upper and lower covers which are movably connected in a pivot manner for easily opening and closing operations, the weight of the upper cover generally reaches 3 to 4 kg, and the upper cover will suddenly fall and be closed when such articles are used, resulting in undesirable noise and/or accidental injury.

To solve this problem, a cushioning member is disposed between the upper cover and the lower cover. However, it is observed that most of the existing cushions can only operate normally at room temperature and will be failed or damaged if the temperature is slightly higher, so that a good cushioning effect cannot be achieved, and the safety problem is caused again. For example, it is common for ovens in European and American families. Since such ovens are exposed to a high temperature for a long time, general cushioning are not applicable.

Meanwhile, the existing cushioning mechanisms are complex in structure, resulting in high production design cost. In addition, the existing cushioning mechanism cannot control the falling speed of the upper cover well, so that accidental injuries still occur occasionally. As a result, when ovens and other products are sold and exhibited, the upper cover is often tied to avoid the sudden fall of the upper cover during the purchase process of purchasers from hurting the purchasers or the oven itself. Therefore, it is not a good idea.

### SUMMARY OF THE INVENTION

It is a first object of the present invention to provide a cushioning mechanism which is applicable in a high temperature environment, simple in structure and good in cushioning effect.

It is a second object of the present invention to provide an oven applying the cushioning mechanism.

For achieving the first object, a cushioning mechanism disposed between a first main body and a second main body, the second main body connecting to the first main body and capable of rotating relative to the first main body, the cushioning mechanism comprising: a cushioning part; a first cushioning member disposed the first main body; a second cushioning member disposed on the second main body; wherein, the second cushioning member is capable of rotating together with the second main body in a circular motion relative to the first cushioning member; during movement of the second cushioning member, the cushioning part cooperates with the first cushioning member or the second cushioning member to resist the movement velocity of the second cushioning member.

Preferably, the first cushioning member is an arc-shaped solid piece and the second cushioning member is an arc-shaped hollow tube corresponding to the first cushioning member;
a first end of the second cushioning member has an opening for allowing one end of the first cushioning member to insert inside, a second end of the second cushioning member is closed, when the second cushioning member moves relative to the first cushioning member in a concentric circular motion, the first cushioning member slides inside the hollow second cushioning member along a length of the first cushioning member;
the cushioning part is disposed inside the hollow second cushioning member, when the second cushioning member moves to engulf the first cushioning member, the one end of the first cushioning member applies an opposite acting force to the second cushioning member through the cushioning part so as to resist the movement velocity of the second cushioning member.

Preferably, the first cushioning member is an arc-shaped solid piece and the second cushioning member is an arc-shaped hollow tube corresponding to the first cushioning member;
a first end of the second cushioning member has an opening for allowing one end of the first cushioning member to insert inside, when the second cushioning member moves relative to the first cushioning member in a concentric circular motion, the first cushioning member slides inside the hollow second cushioning member along a length of the first cushioning member;
the cushioning part is sleeved out of the first cushioning member, when the second cushioning member moves relative to the first cushioning member, the cushioning part applies an opposite acting force to the second cushioning member so as to resist the movement velocity of the second cushioning member.

Preferably, the second cushioning member is an arc-shaped solid piece and the first cushioning member is an arc-shaped hollow tube corresponding to the second cushioning member;
a first end of the first cushioning member has an opening for allowing one end of the second cushioning member to insert inside, a second end of the first cushioning member is closed, when the second cushioning member moves relative to the first cushioning member in a concentric circular motion, the second cushioning member slides inside the hollow first cushioning member along a length of the first cushioning member;
the cushioning part is disposed inside the hollow first cushioning member, when the second cushioning member moves relative to the first cushioning member, the cushioning part applies an opposite acting force to the second cushioning member so as to resist the movement velocity of the second cushioning member.

Preferably, the second cushioning member is an arc-shaped solid piece and the first cushioning member is an arc-shaped hollow tube corresponding to the second cushioning member;
a first end of the first cushioning member has an opening for allowing one end of the second cushioning member to insert inside, a second end of the first cushioning member is closed, when the second cushioning member moves relative to the first cushioning member in a concentric circular motion, the second cushioning member slides inside the hollow first cushioning member along a length of the first cushioning member;
the cushioning part is sleeved out of the second cushioning member, when the second cushioning member moves relative to the first cushioning member, the one end of the first cushioning member applies an opposite acting force to the second cushioning member through the cushioning part so as to resist the movement velocity of the second cushioning member.

Preferably, the cushioning part is a spring disposed inside the hollow second cushioning member touching the second end of the second cushioning member.

Preferably, the first cushioning member is connected to the first main body through a fixing seat, the cushioning part is a spring sleeved out of the first cushioning member and touching the fixing seat.

Preferably, the cushioning part is a spring disposed inside the hollow first cushioning member and touching the second end of the first cushioning member.

Preferably, the second cushioning member is connected to the second main body through a fixing seat, the cushioning part is a spring sleeved out of the second cushioning member and touching the fixing seat.

Preferably, the one end of the first cushioning member is located inside the second cushioning member when the second main body is in an open state relative to the first main body.

Preferably, the one end of the second cushioning member is located inside the first cushioning member when the second main body is in an open state relative to the first main body.

An oven having the cushioning mechanism comprises an inner cover and an outer cover, wherein the first main body is the inner cover of the oven and the second main body is the outer cover of the oven.

Preferably, the first cushioning member is attached to the inner cover through the fixing seat which is connected to a second end of the first cushioning member;

the second cushioning member is attached to the outer cover through a plurality of fixing seats disposed at intervals.

Preferably, the first cushioning member is attached to the inner cover through a plurality of fixing seats disposed at intervals, the second cushioning member is attached to the outer cover through the fixing seat connected to a second end of the second cushioning member.

Preferably, the first cushioning member and the second cushioning member are correspondingly disposed on an outer surface of the inner cover and an outer surface of the outer cover, respectively.

Compared with the prior art, the present invention has the following advantages.

By cooperating the arc-shaped solid piece with the arc-shaped hollow tube and by making a spring or other cushioning portions be disposed in the arc-shaped hollow tube or sheathing a spring or other cushioning portions on the periphery of the arc-shaped solid piece, when the arc-shaped hollow tube or the arc-shaped solid piece does a concentric circular motion relative to each other, an opposite acting force is applied to the movement object, so that the problem that the previous cushioning mechanism cannot control the falling speed of the outer cover of the oven is skillfully solved, and a good cushioning effect is ensured. Moreover, this structure is simple and has low requirements for the service environment, so that the applicability of the cushioning mechanism is improved.

### BRIEF DESCRIPTION OF THE DRAWINGS

FIG. 1 is a perspective view of an oven having the cushioning mechanism according to the present invention when in an open state;

FIG. 2 is a perspective view of an oven having the cushioning mechanism according to the present invention when in a closed state.

### DETAILED DESCRIPTION OF THE INVENTION

The present invention will be further described below in detail by embodiments with reference to the accompanying drawings, throughout which the same or similar reference numerals indicate the same or similar elements or elements having the same or similar functions. The embodiments described below with reference to the accompanying drawings are illustrative, merely used for explaining the present invention and should not be regarded as any limitations thereto.

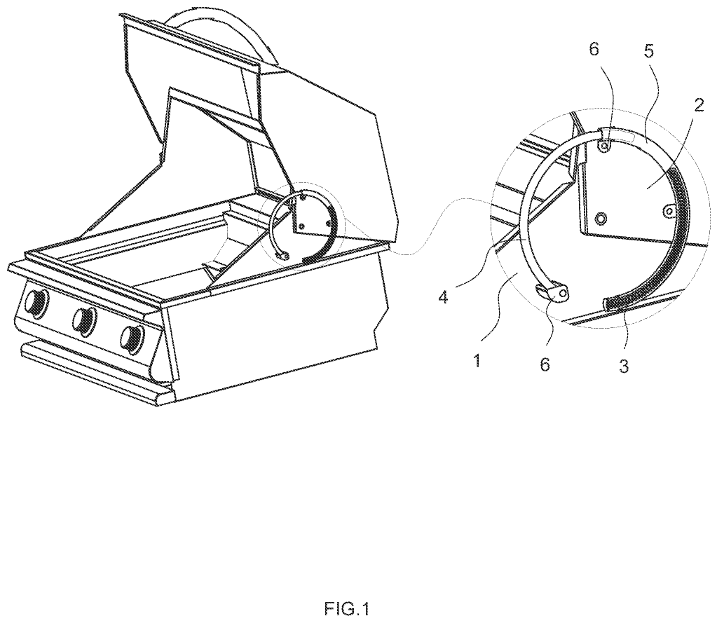

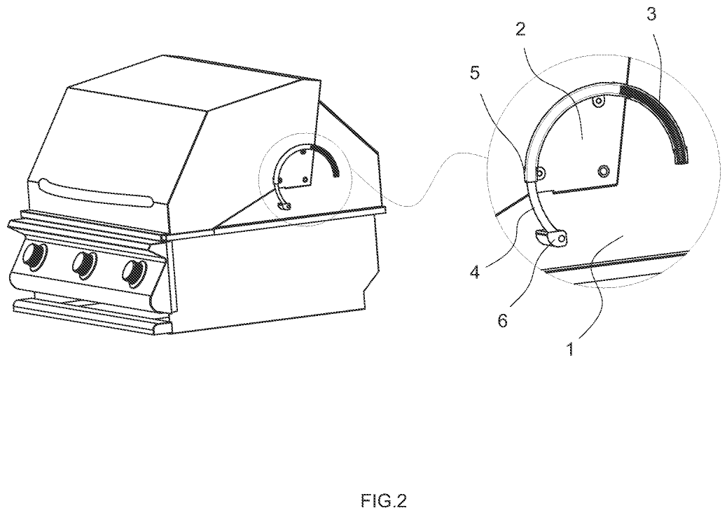

FIGS. 1-2 show a preferred embodiment of an oven having the cushioning mechanism ac cording to the present invention. It is to be noted that, the application range of the cushioning mechanism of the present invention is not limited to ovens and can be applied to products such as toilets or pianos. Here, for convenience of description, it is preferred to take an oven as an example.

As described above, the cushioning mechanism of the present invention is applied to various products. Correspondingly, the cushioning mechanism disposed between a first main body 1 and a second main body 2, the second main body 2 connecting to the first main body 1 and capable of rotating relative to the first main body 1, the cushioning mechanism comprises a cushioning part 3; a first cushioning member 4 disposed on the first main body 1; a second cushioning member 5 disposed on the second main body 2; wherein, the second cushioning member 5 is capable of rotating together with the second main body 2 in a circular motion relative to the first cushioning member 4; during movement of the second cushioning member 5, the cushioning part 3 cooperates with the first cushioning member 4 or the second cushioning member 5 to resist the movement velocity of the second cushioning member 5.

The circular motion can increase the movement distance of the cushioning mechanism, so that the cushioning effect is more remarkable. In addition, by cooperating with the cushioning portion to slow down the movement velocity of the second cushioning member, the cushioning effect can be better improved.

The cushioning members specifically correspond to the following situations. The first cushioning member 4 is an arc-shaped solid piece and the second cushioning member 5 is an arc-shaped hollow tube corresponding to the first cushioning member 4; a first end of the second cushioning member 5 has an opening for allowing one end of the first cushioning member 4 to insert inside, a second end of the second cushioning member 5 is closed, when the second cushioning member 5 moves relative to the first cushioning member 4 in a concentric circular motion, the first cushioning member 4 slides inside the hollow second cushioning member 5 along a length of the first cushioning member; the cushioning part 3 is disposed inside the hollow second cushioning member 5, when the second cushioning member 5 moves to engulf the first cushioning member 4, the one end of the first cushioning member 4 applies an opposite acting force to the second cushioning member 5 through the cushioning part 3 so as to resist the movement velocity of the second cushioning member 5. This is a first embodiment.

In this case, to ensure a reliable and effective cushioning effect, the first cushioning member 4 is an arc-shaped solid piece, for example, an arc-shaped solid bar made of a rigid metal material. The solid piece is firm and can well bear the weight of the second main body, for example, the upper cover of the oven. Correspondingly, the cushioning part 3 is a spring, and is located in a cavity of the second cushioning member 5 and comes into contact with the other end of the second cushioning member 5. By coming into contact with the other end of the second cushioning member 5, a support surface can be provided for the spring, so that a good cushioning effect is ensured.

Of course, the cushioning part 3 may also be sleeved on the periphery of the first cushioning member 4. This is a second embodiment. However, in this case, the end of the second cushioning member 5 directly reacts with the cushioning part 3. That is, when the second cushioning portion 5 moves relative to the first cushioning member 4, the cushioning part 3 directly applies an opposite acting force to the one end of the second cushioning member 5, so as to slow down the movement velocity of the second cushioning member 5 (this structure is not shown in Figs).

In addition, it is to be mentioned that, in this case, the other end of the second cushioning member 5 does not need to be closed and may also be an opening, that is, the second cushioning member 5 may be a cut-through tube. Obviously, the length of the second cushioning 5 is not strictly required in this case; however, to ensure a good cushioning effect, the cushioning part 3 needs to be able to provide a sufficient and appropriate cushioning force, so that the outer cover of the oven in the embodiment of the present invention can be closed when the movement velocity of the second cushioning member 5 is slowed down.

To provide a firm structure, in this case, the first cushioning member 4 is still preferably an arc-shaped solid piece, for example, being made of a rigid metal material. The first cushioning member 4 is fixedly connected to the first main body 1 through a fixed seat, and the cushioning part 3 is a spring and is sleeved on the first cushioning member 4. To achieve a better cushioning effect, the end of the spring comes into contact with the fixed root portion of the first cushioning member 4.

In the above two preferred embodiments, the second cushioning member 5 of a hollow tube moves relative to the first cushioning member 4 of an arc-shaped structure. Obviously, the both may be exchanged, that is, the second cushioning member 5 may be of an arc-shaped structure, and the first cushioning member 4 is of a concentric hollow tube.

In other words, the cushioning mechanism of the present invention may also correspond to the following situation: one end of the first cushioning member 4 of a concentric hollow tube is open so that the one end of the second cushioning member 5 extends into the first cushioning member 4 during the movement of the second cushioning member 5 of an arc-shaped structure and the second cushioning member 5 does a concentric circle motion relative to the first cushioning member 4 in the tube.

In this case, there are also two situations. One situation is that: the other end of the first cushioning member 4 is closed, the cushioning part 3 is disposed in the first cushioning member 4, and when the second cushioning member 5 moves relative to the first cushioning member 4, the cushioning part 3 directly applies an opposite acting force to the one end of the second cushioning member 5 to slow down the movement velocity of the second cushioning member 5. This is a third embodiment (this structure is not shown in Figs).

In this case, the second cushioning member 5 is an arc-shaped solid piece made of a rigid metal material, and the cushioning part 3 is a spring and is located in a cavity of the first cushioning member 4 and comes into contact with the other end of the first cushioning member 4, thereby ensuring a better cushioning effect.

Another situation is a fourth embodiment (this structure is not shown in Figs): the cushioning part 3 is sleeved on the periphery of the second cushioning member 5, and when the second cushioning member 5 moves relative to the first cushioning member 4, the one end of the first cushioning member 4 applies an opposite acting force to the second cushioning member 5 through the cushioning part 3 to slow down the movement velocity of the second cushioning member 5. Also, in this case, it doesn't matter whether the other end of the first cushioning member 4 is closed, as long as the cushioning part 3 can exert a sufficient and appropriate acting force on the first cushioning member 4 during the movement of the second cushioning member 5, so that the first cushioning member 4 can apply an opposite acting force to the second cushioning member 5 through the cushioning part 3 to slow down the movement velocity of the second cushioning member 5, thereby achieving a good cushioning effect.

Also, the second cushioning member 5 is an arc-shaped solid piece and is fixedly connected to the second main body 2 through a fixed seat, and the cushioning part 3 is a spring and is sleeved on the second cushioning member 5 and comes into contact with the fixed root portion of the second cushioning member 5, thereby providing a reliable and effective cushioning force.

For the above four embodiments, it is to be noted that, in the second and fourth embodiments, the spring is sleeved on the periphery of the arc-shaped solid piece. Since the spring is exposed to the outside, compared with the spring being disposed in the hollow tube, that is, compared with the first and third embodiments, it is easy to damage the spring by an external force. In the latter case, since the spring is hidden in an arc-shaped hollow tube, the spring can be well protected from damage by an external force. Therefore, compared with the second and fourth embodiments, in the first and third embodiments, the cushioning mechanism has a longer service life. However, it does not mean that the second and fourth embodiments are not feasible. On the contrary, the second or fourth embodiments may be preferred according to the actual needs in the actual production process.

Moreover, by making the first cushioning member and the second cushioning member as an arc-shaped piece, compared with the cushioning mechanism in the form of a straight line or the cushioning mechanism moving in a straight line in the prior art, the structure of the present invention can increase the cushioning distance by using the characteristics of the arc-shaped piece, so that it is convenient to better improve the cushioning effect, and the cushioning effect is more remarkable. Moreover, by using the curvy characteristic of the arc-shaped piece, the structure design is more aesthetic.

In the present invention, an oven is taken as an example, it applies the first embodiment. As shown in FIGS. 1-2, the first main body 1 is an inner cover of the oven, and the second main body 2 is an outer cover of the oven. The first cushioning member 4 is fixedly connected to the inner cover 1 through a fixed seat 6 that is connected to the other end of the first cushioning member 4, and the second cushioning member 5 is fixedly connected to the outer cover 2 through a plurality of fixed seats 6 that are disposed at intervals. Obviously, when the third and fourth embodiments are adopted, correspondingly, the first cushioning member 4 is fixedly connected to the inner cover through a plurality of fixed seats that are disposed at intervals, and the second cushioning member 5 is fixedly connected to the outer cover through fixed seat that is connected to the other end of the second cushioning member 5 (this structure is not shown in Figs).

To avoid the situation where the arc-shaped solid piece cannot accurately extend into the hollow tube due to jitter during the action of the cushioning mechanism when the cushioning mechanism acts, the one end of the first cushioning member 4 is located in the second cushioning member 5 when the outer cover 2 is in an open state. This structure is also applicable for the second embodiments. For the third and fourth embodiments, correspondingly, the one end of the second cushioning member 5 is located in the first cushioning member 4 when the outer cover 2 is in an open state.

It is easily conceived that, to prolong the service life of the cushioning mechanism, the first cushioning member 4 and the second cushioning member 5 are correspondingly disposed on the outer sidewall of the inner cover 1 and the outer sidewall of the outer cover 2, respectively. Of course, it may also be designed that the first cushioning member 4 and the second cushioning member 5 are correspondingly disposed on the inner sidewall of the inner cover 1 and the inner sidewall of the outer cover 2, respectively. However, it is to be noted that the service life of the cushioning mechanism may be shortened in this way. Therefore, it is more possible to adopt the structures in the oven embodiments of the present invention in the actual design.

In the present invention, by cooperating the arc-shaped solid piece with the arc-shaped hollow tube and by making a spring or other cushioning portions be disposed in the arc-shaped hollow tube or sheathing a spring or other cushioning portions on the periphery of the arc-shaped solid piece, when the arc-shaped hollow tube or the arc-shaped solid piece does a concentric circular motion relative to each other, an opposite acting force is applied to the movement object, so that the problem that the previous cushioning mechanism cannot control the falling speed of the outer cover of the oven is skillfully solved, and a good cushioning effect is ensured. Moreover, this structure is simple and has low requirements for the service environment, so that the applicability of the cushioning mechanism is improved.

Although embodiments of the present invention have been shown and described, technicians in this field may understand that various changes, modifications, substitutions and deformation of these embodiments can be made without departing from the principles and purposes of the invention, and the scope of the invention is defined by the claims and their equivalent.

1. A cushioning mechanism disposed between a first main body (1) and a second main body (2), the second main body (2) connecting to the first main body (1) and capable of rotating relative to the first main body (1), the cushioning mechanism comprising:
a cushioning part (3);
a first cushioning member (4) disposed the first main body (1);
a second cushioning member (5) disposed on the second main body (2);
wherein,
the second cushioning member (5) is capable of rotating together with the second main body (2) in a circular motion relative to the first cushioning member (4);
during movement of the second cushioning member (5), the cushioning part (3) cooperates with the first cushioning member (4) or the second cushioning member (5) to resist the movement velocity of the second cushioning member (5).

2. The cushioning mechanism of claim 1, wherein the first cushioning member (4) is an arc-shaped solid piece and the second cushioning member (5) is an arc-shaped hollow tube corresponding to the first cushioning member (4);
a first end of the second cushioning member (5) has an opening for allowing one end of the first cushioning member (4) to insert inside, a second end of the second cushioning member (5) is closed, when the second cushioning member (5) moves relative to the first cushioning member (4) in a concentric circular motion, the first cushioning member (4) slides inside the hollow second cushioning member (5) along a length of the first cushioning member;
the cushioning part (3) is disposed inside the hollow second cushioning member (5), when the second cushioning member (5) moves to engulf the first cushioning member (4), the one end of the first cushioning member (4) applies an opposite acting force to the second cushioning member (5) through the cushioning part (3) so as to resist the movement velocity of the second cushioning member (5).

3. The cushioning mechanism of claim 1, wherein the first cushioning member (4) is an arc-shaped solid piece and the second cushioning member (5) is an arc-shaped hollow tube corresponding to the first cushioning member (4);
a first end of the second cushioning member (5) has an opening for allowing one end of the first cushioning member (4) to insert inside, when the second cushioning member (5) moves relative to the first cushioning member (4) in a concentric circular motion, the first cushioning member (4) slides inside the hollow second cushioning member (5) along a length of the first cushioning member;
the cushioning part (3) is sleeved out of the first cushioning member (4), when the second cushioning member (5) moves relative to the first cushioning member (4), the cushioning part (3) applies an opposite acting force to the second cushioning member (5) so as to resist the movement velocity of the second cushioning member (5).

4. The cushioning mechanism of claim 1, wherein the second cushioning member (5) is an arc-shaped solid piece and the first cushioning member (4) is an arc-shaped hollow tube corresponding to the second cushioning member (5);
a first end of the first cushioning member (4) has an opening for allowing one end of the second cushioning member (5) to insert inside, a second end of the first cushioning member (4) is closed, when the second cushioning member (5) moves relative to the first cushioning member (4) in a concentric circular motion, the second cushioning member (5) slides inside the hollow first cushioning member (4) along a length of the first cushioning member;
the cushioning part (3) is disposed inside the hollow first cushioning member (4), when the second cushioning member (5) moves relative to the first cushioning member (4), the cushioning part (3) applies an opposite acting force to the second cushioning member (5) so as to resist the movement velocity of the second cushioning member (5).

5. The cushioning mechanism of claim 1, wherein the second cushioning member (5) is an arc-shaped solid piece and the first cushioning member (4) is an arc-shaped hollow tube corresponding to the second cushioning member (5);
a first end of the first cushioning member (4) has an opening for allowing one end of the second cushioning member (5) to insert inside, a second end of the first cushioning member (4) is closed, when the second cushioning member (5) moves relative to the first cushioning member (4) in a concentric circular motion, the second cushioning member (5) slides inside the hollow first cushioning member (4) along a length of the first cushioning member;
the cushioning part (3) is sleeved out of the second cushioning member (5), when the second cushioning member (5) moves relative to the first cushioning member (4), the one end of the first cushioning member (4) applies an opposite acting force to the second cushioning member (5) through the cushioning element (3) so as to resist the movement velocity of the second cushioning member (5).

6. The cushioning mechanism of claim 2, wherein the cushioning part (3) is a spring disposed inside the hollow second cushioning member (5) touching the second end of the second cushioning member (5).

7. The cushioning mechanism of claim 3, wherein the first cushioning member (4) is connected to the first main body (1) through a fixing seat (6), the cushioning part (3) is a spring sleeved out of the first cushioning member (4) and touching the fixing seat.

8. The cushioning mechanism of claim 4, wherein the cushioning part (3) is a spring disposed inside the hollow first cushioning member (4) and touching the second end of the first cushioning member (4).

9. The cushioning mechanism of claim 5, wherein the second cushioning member (5) is connected to the second main body (2) through a fixing seat, the cushioning part (3) is a spring sleeved out of the second cushioning member (5) and touching the fixing seat.

10. The cushioning mechanism of claim 2, wherein the one end of the first cushioning member (4) is located inside the second cushioning member (5) when the second main body (2) is in an open state relative to the first main body (1).

11. The cushioning mechanism of claim 4, wherein the one end of the second cushioning member (5) is located inside the first cushioning member (4) when the second main body (2) is in an open state relative to the first main body (1).

12. An oven having the cushioning mechanism of claim 1, comprising an inner cover and an outer cover, wherein the first main body (1) is the inner cover of the oven and the second main body (2) is the outer cover of the oven.

13. The oven of claim 12, wherein the first cushioning member (4) is attached to the inner cover through the fixing seat (6) which is connected to a second end of the first cushioning member (4);
the second cushioning member (5) is attached to the outer cover through a plurality of fixing seats (6) disposed at intervals.

14. The oven of claim 12, wherein the first cushioning member (4) is attached to the inner cover through a plurality of fixing seats (6) disposed at intervals, the second cushioning member (5) is attached to the outer cover through the fixing seat (6) connected to a second end of the second cushioning member (5).

15. The oven of claim 12, wherein the first cushioning member (4) and the second cushioning member (5) are correspondingly disposed on an outer surface of the inner cover and an outer surface of the outer cover, respectively.
